(19) United States
(12) Patent Application Publication
(10) Pub. No.: US 2022/0227041 A1
(43) Pub. Date: Jul. 21, 2022

(54) FUSING BUILD MATERIAL BASED ON THERMAL TRANSFER

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/608,529

(22) PCT Filed: Sep. 9, 2019
(86) PCT No.: PCT/US2019/050166

§ 371 Date: Nov. 3, 2021

(51) Int. Cl. B29C 64/165; B29C 64/282; B29C 64/268; B29C 64/393; B33Y 30/00; B33Y 50/02

(52) U.S. Cl. CPC B29C 64/165; B29C 64/282; B29C 64/268; B33Y 10/00; B33Y 30/00; B33Y 50/02; B29C 64/393

(57) ABSTRACT

An example system includes a plurality of energy emitters to deliver energy to a material bed to fuse build material at a plurality of locations receiving the energy. The system also includes a controller to a controller to determine an amount of energy to deliver to each location to achieve a fusing condition based on data indicating the plurality of locations to be fused and based on predicted thermal transfer between the plurality of locations receiving the energy. The controller also is to cause the plurality of energy emitters to deliver the determined amount of energy to each location of the material bed.

### BACKGROUND

Additive manufacturing is a technique to form three-dimensional (3D) objects by adding material until the object is formed. The material may be added by forming several layers of material with each layer stacked on top of the previous layer. Additive manufacturing is also referred to as 3D printing. Examples of 3D printing include melting a filament to form each layer of the 3D object (e.g., fused filament fabrication), curing a resin to form each layer of the 3D object (e.g., stereolithography), sintering, melting, or binding powder to form each layer of the 3D object (e.g., selective laser sintering or melting, multijet fusion, metal jet fusion, etc.), and binding sheets of material to form the 3D object (e.g., laminated object manufacturing, etc.).

### BRIEF DESCRIPTION OF THE DRAWINGS

FIG. 1 is a block diagram of an example system to fuse build material based on thermal transfer.

FIG. 2 is a block diagram of another example system to fuse build material based on thermal transfer.

FIG. 3 is a flow diagram of an example method to fuse build material based on thermal transfer.

FIG. 4 is a flow diagram of another example method to fuse build material based on thermal transfer.

FIG. 5 is a block diagram of an example computer-readable medium including instructions that cause a processor to determine energy delivery to fuse build material based on thermal transfer.

FIG. 6 is a block diagram of another example computer-readable medium including instructions that cause a processor to determine energy delivery to fuse build material based on thermal transfer.

### DETAILED DESCRIPTION

In some examples, a three-dimensional (3D) printer may include a plurality of energy emitters to deliver energy to the material used to form the 3D object. For example, the material may be a powder, and the energy emitters may deliver energy that sinters or melts the powder or that binds the powder with a binding agent. As used herein, the term “fuse” refers to attaching pieces of material to each other via sintering, melting, or binding with a binding agent. The plurality of energy emitters may deliver energy to selective locations on a material bed to fuse the material at selected locations without fusing the material at unselected locations. For example, the delivered energy may raise the temperature of the material or binder to a temperature sufficiently high to cause the fusing.

After energy has been delivered to the material bed, the locations receiving energy may transfer heat to surrounding locations on the material bed. The heat transfer may be affected by a number of factors. For example, the difference in temperature between the location and the surrounding locations may affect the rate of heat transfer. In addition, fusing of material may allow for more efficient heat transfer between the fused material than between unfused pieces of material separated by small amounts of air. As each layer of a 3D print is added, heat may transfer to a current layer from previous layers. As a result, the current layer may not have a uniform temperature state. Delivering the same amount of energy to different locations of the material bed may produce very different temperatures at those locations.

Fusing of material at a location is affected by the time-temperature profile at that location. Thus, the transfer of heat may affect properties of the 3D object. For example, the edges of a 3D object may be too cool or may cool too quickly, which may result in a high porosity and structural weakness or deformation. The center of a 3D object may become too hot, which may cause material or binding agents to reach a low viscosity state in which they flow away from a desired location. Temperature differences between the various locations of the 3D object due to heat transfer may cause deformation of the 3D object. Accordingly, 3D printing with a plurality of energy emitters could be improved by controlling the amount of energy delivered to account for heat transfer among locations of the material bed before or after the energy has been delivered.

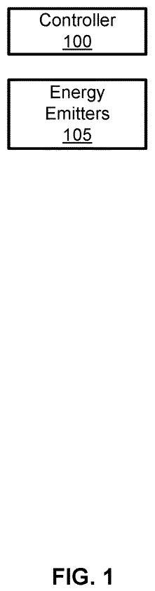

FIG. 1 is a block diagram of an example system to fuse build material based on thermal transfer. The example shown includes controller 100 and energy emitters 105. As used herein, the term “controller 100” refers to hardware (e.g., analog or digital circuitry, a processor, such as an integrated circuit, or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random-access memory (RAM), a hard-disk or solid-state drive, resistive memory, or optical media such as a digital versatile disc (DVD), and/or executed or interpreted by a processor), or hardware and software hosted at hardware.

Energy emitters 105 may deliver energy to a material bed to fuse build material at a plurality of locations receiving the energy. In some examples, the set of energy emitters 105 includes a one-dimensional (1D) or two-dimensional (2D) array of lasers, an array of mirrors to reflect energy from an energy emitter (e.g., a flash lamp) towards the material bed, or the like. For example, the 1D or 2D array of lasers may scan across (e.g., move parallel to a surface of) the material bed and deliver the energy to the locations of the material bed while scanning. In some examples, the plurality of energy emitters 105 may be stationary relative to the material bed. The lasers may be turned on or off, or the amount of power may be varied based on the locations of the lasers with respect to the material bed. The 1D or 2D array of lasers may be an array of vertical-cavity surface-emitting lasers (VCSELs). In examples including an array of mirrors, the mirrors may be micro-mirrors that can transition between a position or orientation that reflects energy towards the material bed and a position or orientation that reflects energy away from the material bed. Energy emitters 105 or a separate energy emitter may be used to heat material in regions of the material bed that are will not be fused. For example, the energy emitters 105 or the separate energy emitter may pre-heat the material bed, may heat the regions not being fused to reduce a thermal gradient relative to areas that are being fused (e.g., to reduce thermal transfer or prevent deformation), or the like.

Controller 100 may determine an amount of energy to deliver to each location to achieve a fusing condition based on data indicating the plurality of locations to be fused and based on predicted thermal transfer between the plurality of locations receiving the energy. As used herein, the term “fusing condition” refers to a temperature or temperature and time that will result in fusing of material. For example, the fusing condition may include exceeding a recrystallization temperature of a material, exceeding the recrystallization temperature by a predetermined temperature, for a predetermined time, or according to a combination of temperature and time satisfying a predetermined condition. The fusing condition may be selected to include a sufficiently large temperature or time to avoid high porosity or structural weakness in the fused locations.

Controller 100 may for each of a set of locations of a build material bed, compute the amount of energy to be received from other locations of the build material bed. Controller 100 may receive the data indicating the plurality of locations to be fused. Controller 100 may compute the amount of energy to deliver to each location using the set of energy emitters 105 to achieve the fusing condition at the locations to be fused. Controller 100 may compute the amount of energy to deliver to achieve the fusing condition based on the amount of energy to be received from the other locations. For example, controller 100 may determine that locations that receive high amounts of energy from surrounding locations of the build material bed should receive less energy from the energy emitters 105 and vice versa. Controller 100 may determine the amount of energy to deliver to each location using the set of energy emitters 105 to ensure the fusing condition does not occur at locations not to be fused. For example, controller 100 may determine the amount of energy to ensure that the condition of the locations not to be fused are at least a predetermined offset below the fusing conditions.

Controller 100 may compute the amount of energy to be received from other locations of the build material bed by generating a heat map. As used herein, the term “heat map” refers to an array of values corresponding to potential thermal states of locations on a build material bed. Controller 100 may determine the heat map based on data indicating locations of a build material bed to be fused and based on predicted thermal transfer between the locations to be fused. The locations of the build material bed to be fused may be the locations that will receive energy from the energy emitters 105 and thus will transfer heat to surrounding locations. Accordingly, controller 100 may determine the amount of energy that will be received at each location from the locations receiving energy from the energy emitters 105. Controller 100 may also, or instead, determine the amount of energy that will be lost from the location due to transfer to other nearby locations. Controller 100 may compute the amount of energy to be received at each location based on a thermal state of a previous layer of the build material bed that already received energy from the set of energy emitters 105, a predicted thermal state of a current layer of the build material, or a predicted thermal state of a future layer of the build material. As used herein, the term “current layer” refers to a layer of a 3D object that is being or is about to be formed. The term “previous layer” refers to a layer of a 3D object that has already been formed. The term “future layer” refers to a layer of a 3D object other than the current layer that has not yet been formed.

Controller 100 may determine the heat map by convolving a kernel with a 3D model or portion of a 3D model (e.g., a slice or a plurality of slices of the 3D model). Convolving with the kernel may model thermal transfer between the locations of the build material bed. The 3D model may represent locations that will be fused. In other words, the data indicating the location of the build material bed to be fused may include the slice of the 3D model. Each slice of the 3D model may be represented as an array of values (e.g., values indicating whether that location is to be fused or not), and the array of values may be convolved with the kernel. The kernel may be a blurring kernel, such as a Gaussian kernel, a non-Gaussian blurring kernel, or the like. The kernel may be a 2D kernel, a 3D kernel, or the like. For example, controller 100 may convolve a 2D kernel with a slice, a 3D kernel with a plurality of slices (e.g., the slices may include previous slices, a slice to be printed currently, or future slices), or the like. In an example, controller 100 may convolve each slice with a kernel, and the results may be weighted and summed to account for heat transfer between layers. Thus, when determining the heat map for a current slice, controller 100 may convolve a 2D or 3D kernel with previous or future slices to account for heat transfer between layers of the build material bed. In some examples, controller 100 may use a machine learning model to generate the kernel, or controller 100 may use a machine learning model to predict the heat map from the data indicating the locations of the build material bed to be fused.

Controller 100 may also determine an amount of energy to deliver to each location of the build material bed based on the heat map and the data indicating the locations of the build material bed to be fused. One way of understanding the heat map is as an indication of the temperatures that would result if the build material bed were to receive a uniform delivery of a predetermined amount of energy at the locations of the build material bed to be fused (e.g., as a prediction of thermal transfer resulting from uniform delivery). Controller 100 may adjust the amount of energy delivered to each location based on the heat map to ensure the fusing condition is satisfied at the locations to be fused, the fusing condition is not satisfied at locations not to be fused, or an overheating condition does not occur at the locations to be fused. As used herein, the term “overheating condition” refers to a temperature or temperature and time that results in deformation of a 3D object or undesired flowing of material or binder agent in a low-viscosity state. For example, controller 100 may decrease the amount of energy to be delivered to locations that the heat map indicates will experience an overheating condition relative to the predetermined amount of energy. For locations not to be fused that are expected to experience a fusing condition, controller 100 may decrease the amount of energy to be delivered to nearby locations relative to the predetermined amount of energy. Controller 100 may increase the amount of energy delivered to locations that are to be fused but that the heat map indicates will not experience the fusing condition relative to the predetermined amount of energy.

In some examples, controller 100 may compute a predicted thermal state of a future layer prior to delivery of energy to a current layer. Controller 100 may adjust the computed amount of energy to be delivered to each location of a current layer based on the predicted thermal state of the future layer. For example, controller 100 may decrease the amount of energy to be delivered to locations of a current layer if that energy may cause a fusing condition to occur at a location not to be fused or cause an overheating condition to occur in a future layer. Controller 100 may similarly increase the amount of energy to be delivered to locations of a current layer if a fusing condition would otherwise not occur at a location to be fused in a future layer.

Controller 100 may determine parameters of the set of energy emitters 105 to deliver the determined amount of energy. In some examples, controller 100 may cause the plurality of energy emitters 105 to deliver the determined amount of energy to each location by adjusting a power delivered by each emitter or a firing time of each emitter based on the amount of energy to be delivered. Accordingly, controller 100 may determine the firing time or power based on the determined amount of energy for each location. Controller 100 may determine an energy profile for the amount of energy to be deliver to each location. For example, the energy profile may indicate the power delivered at each point in time over a time period to achieve the determined amount of energy. The energy may be delivered in multiple bursts, and the energy profile may correspondingly indicate times when the energy emitters 105 are on and off. In an example with stationary energy emitters, the energy profile for a single emitter may indicate power delivered over time to a single location. In an example with scanning energy emitters, the energy profiles for a plurality of locations along a scan path may be used to control an energy emitter moving along that scan path, for example, by concatenating or combining the energy profiles for the locations along the scan path to create an overall energy profile for that energy emitter. Controller 100 may determine an energy profile that ensures each location along the scan path receives the amount of energy determined by the controller 100 during scanning of the energy emitters 105.

In some examples, multiple of the energy emitters 105 may deliver energy to the same location on the material bed. For example, a first energy emitter may deliver a first amount of energy to a first location and a second energy emitter may deliver a second amount of energy to the first location. The first and second energy emitters may have overlapping or adjacent scan paths. The first and second amounts of energy may sum to be about equal to the determined amount of energy. As used herein, the term “about” refers to a value within a predetermined threshold of the specified value (e.g., within 1%, 2%, 5%, 10%, etc.). For example, the sum may be varied slightly from the determined value to account for differences in energy absorption or heat transfer that result from using multiple bursts of energy rather than a single burst.

When determining the parameters of the set of energy emitters 105, for example, controller 100 may determine a timing for firing each energy emitter to be fired. For example, controller 100 may, to the extent possible, deliver energy to edges first or last, deliver energy to fine features first or last, or the like. In examples, with multiple energy emitters delivering energy to the same location, controller 100 may determine when each energy emitter should deliver energy to that location. In some examples, the timing for firing may be specified by the energy profile which may be defined relative to a predetermined reference point in time (e.g., when scanning of the energy emitters 105 begins).

Controller 100 may cause the plurality of energy emitters 105 to deliver the determined amount of energy to each location of the material bed. In some examples, controller 100 may cause the energy emitters 105 to deliver the determined amount of energy according to the energy profile determined by the controller 100. Energy emitters 105 may deliver the determined amount of energy to fuse build material at the locations of the build material bed to be fused thereby generating a layer of the 3D object. Controller 100 and energy emitters 105 may continue determining amounts of energy deliver, determining energy profiles, or delivering energy to the material bed to form additional layers until the entirety of the 3D object has been printed.

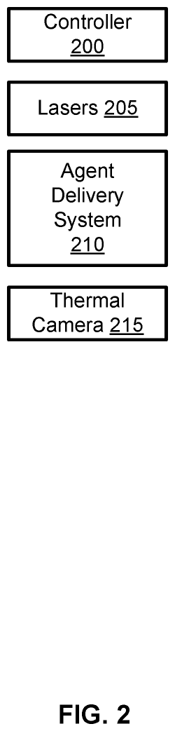

FIG. 2 is a block diagram of another example system to fuse build material based on thermal transfer. The example shown includes controller 200, lasers 205, agent delivery system 210, and thermal camera 215. Controller 200 may be an example of, or include aspects of, controller 100 described with reference to FIG. 1. Similarly, lasers 205 may be an example of, or include aspects of, energy emitters 105 described with reference to FIG. 1. For example, lasers 205 may be scanning or stationary VCSELs. Although this example depicts lasers 205 in combination with an agent delivery system 210 and a thermal camera 215, examples are contemplated in which other energy emitters are used in combination with the agent delivery system 210 and the thermal camera 215 or one but not the other of the agent delivery system 210 or the thermal camera 215 is included.

Agent delivery system 210 may apply an agent to additional locations on the material bed. The additional locations can be the same as, overlapping with (e.g., not mutually exclusive with), mutually exclusive with, a subset of, or a superset of the locations to which the lasers 205 deliver energy. In examples, agent delivery system 210 may deliver an agent to promote fusing of the build material, a cooling agent, an agent that inhibits fusing of the build material, a binding agent, an agent that changes a visual property (e.g., color, opacity, etc.), an agent that changes a physical property (e.g., a property other than a visual property, such as strength, elasticity, etc.), or the like. Controller 200 may determine an amount of agent to deliver to each location of the build material bed, for example, to achieve a specified property, to control fusing behavior, or the like. When determining the amount of energy to deliver to each location, controller 200 may determine the amount of energy to deliver to each location based on the amount or type of agent determined for each location in addition to or instead of the heat map and the data indicating the locations of the build material bed to be fused. For example, a location that receives an agent to color that location yellow may absorb energy less well than a location that receives an agent to color that location magenta. Accordingly, controller 200 may determine the yellow location should receive more energy than the magenta location in a situation in which both locations receive similar amounts of energy from surrounding locations.

Some agents may affect how much energy from the lasers 205 is absorbed but not how much energy is received from surrounding locations, some agents may affect how much energy is received from surrounding locations but not how much energy from the lasers 205 is absorbed, some agents may affect both how much energy is received and how much is absorbed, and some agents may affect neither. Controller 200 may determine what impact the agent will have and adjust calculations accordingly. For agents that affect how much energy is received from surrounding locations, controller 200 may adjust the determination of how much energy is received by a location from neighboring locations, for example, by adjusting that location of the heat map based on the amount of agent to be delivered to that location. For agents that affect absorption of energy from lasers 205, controller 200 may adjust the determination of the amount of energy to deliver to a location, for example, based on the amount of agent to be delivered to that location. Agent delivery system 210 may apply the agent before or after energy is delivered to the build material bed, which may have different impacts on the thermal properties of the build material bed. Thus, controller 200 may make different adjustments depending on whether the agent is delivered before or after the energy.

Thermal camera 215 may capture images of each layer at any of various states, such as before or after an agent is delivered to the build material bed, before or after energy is delivered to the build material bed, or the like. Controller 200 may adjust the amount of energy it determined to deliver to the build material bed or adjust calculations of the amount of energy to deliver to the build material bed based on the image captured by the thermal camera 215. For example, controller 200 may compute the thermal state of the previous layer based on a thermal image of the previous layer. The computed thermal state may indicate that locations of the build material bed are hotter or colder than would be predicted based on previous amounts of energy delivered or previous determinations of energy transfer among locations. In some examples, when convolving slices of a 3D model with a kernel, controller 200 may adjust previous layers of the 3D model, for example, to have values based on the temperature values from the thermal image rather than binary values. Previous layers may also, or instead, be adjusted based on models, previous energy delivery, or the like. For example, thermal values of previous layers may be predicted by a model and adjusted based on thermal images from thermal camera 215.

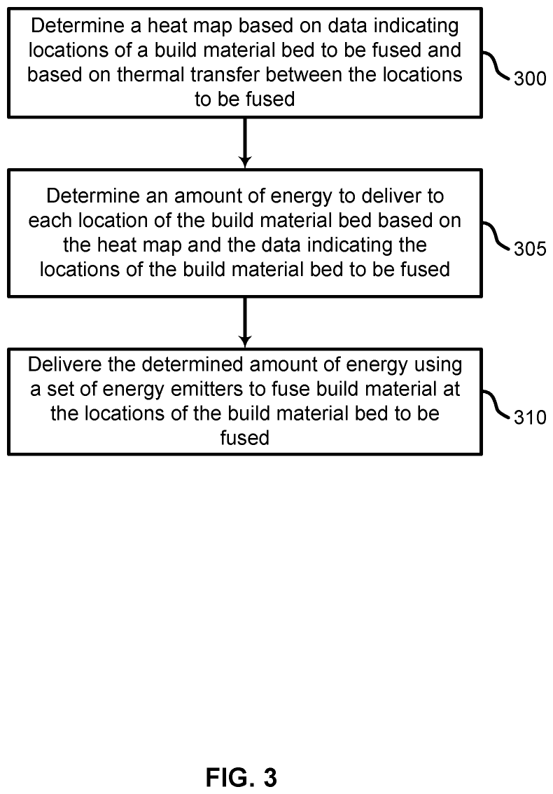

FIG. 3 is a flow diagram of an example method to fuse build material based on thermal transfer. In some examples, these operations may be performed by a system including a processor executing a set of instructions to control functional elements of an apparatus. Additionally or alternatively, the processes may be performed using special-purpose hardware. Generally, these operations may be performed according to the methods and processes described in accordance with aspects of the present disclosure. For example, the operations may be composed of various sub-operations, or may be performed in conjunction with other operations described herein.

At operation 300, the system determines a heat map based on data indicating locations of a build material bed to be fused and based on predicted thermal transfer between the locations to be fused. For example, operation 300 may include determining how energy delivered to locations to be fused will be transferred to surrounding locations of the build material bed. The heat map may represent the results of the transfer of the energy to surrounding locations. In some cases, this operation may refer to, or be performed by, a controller as described with reference to FIGS. 1 and 2.

At operation 305, the system determines an amount of energy to deliver to each location of the build material bed based on the heat map and the data indicating the locations of the build material bed to be fused. For example, operation 305 may include determining an amount of energy that will achieve or avoid a particular condition (e.g., a fusing condition, an overheating condition, etc.) at locations of the build material bed. The particular condition for each location may be determined based on the data indicating the locations of the build material bed to be fused. The amount of energy that will achieve or avoid each condition may be determined based on the heat map. In some cases, this operation may refer to, or be performed by, a controller as described with reference to FIGS. 1 and 2.

At operation 310, the system delivers the determined amount of energy using a set of energy emitters to fuse build material at the locations of the build material bed to be fused. For example, determining the amount of energy to deliver at operation 305 may include determining control parameters for the set of energy emitters to achieve delivery of the determined amount of energy. Delivering the determined amount of energy may include operating the set of energy emitters according to the determined control parameters. In some cases, this operation may refer to, or be performed by, energy emitters as described with reference to FIG. 1 or lasers as described with reference to FIG. 2.

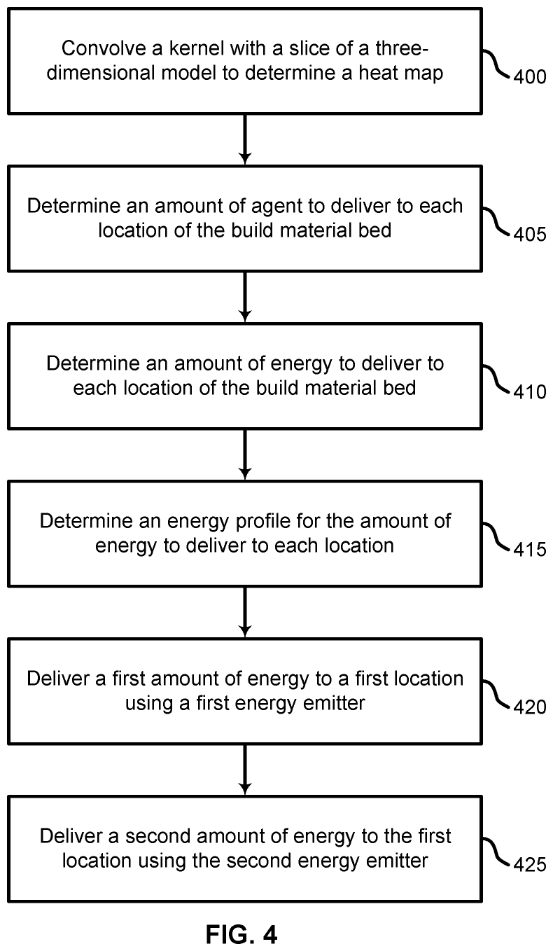

FIG. 4 is a flow diagram of another example method to fuse build material based on thermal transfer. In some examples, these operations may be performed by a system including a processor executing a set of instructions to control functional elements of an apparatus. Additionally or alternatively, the processes may be performed using special-purpose hardware. Generally, these operations may be performed according to the methods and processes described in accordance with aspects of the present disclosure. For example, the operations may be composed of various sub-operations, or may be performed in conjunction with other operations described herein.

At operation 400, the system convolves a kernel with a slice of a 3D model to determine a heat map. For example, the slice may indicate which locations of the build material bed are to be fused to form the 3D model. Convolving the kernel with the slice of the 3D model may approximate how energy will be transferred among locations after delivery of energy to the locations to be fused. The kernel may be convolved with slices corresponding to previous, current, or future layers of the 3D object to determine the heat map The kernel may be selected to generate a heat map indicative of thermal transfers that would result from delivery of a predetermined amount of energy. In some cases, this operation may refer to, or be performed by, a controller as described with reference to FIGS. 1 and 2.

At operation 405, the system determines an amount of agent to deliver to each location of the build material bed. For example, a user may have specified a property (e.g., a visual property, a non-visual, physical property, etc.) of a location of the build material. The system may determine an amount of agent to deliver to achieve that property. In some examples, the agent may assist with achieving a thermal condition, and the system may determine the amount of agent to deliver to achieve that thermal condition. In some cases, this operation may refer to, or be performed by, a controller as described with reference to FIGS. 1 and 2.

At operation 410, the system determines an amount of energy to deliver to each location of the build material bed. The amount of energy may be determined based on the heat map, data indicating whether a location is to be fused or not, and the amount of agent delivered. For example, the system may determine whether to achieve or avoid a fusing condition at each location based on the data indicating whether the location is to be fused. The system may determine a thermal state that would result from delivering a predetermined amount of energy based on the heat map, which may be indicative of predicted thermal transfers among locations, and the amount of agent delivered, which may affect how much energy will be absorbed at the location. The system may determine whether the thermal state is consistent with the conditions to be achieved or avoided (e.g., the fusing condition, an overheating condition, etc.). The system may adjust the amount of energy to be delivered if the thermal state of the location or of a nearby location is not consistent with the conditions to be achieved or avoided at that location. In some cases, this operation may refer to, or be performed by, a controller as described with reference to FIGS. 1 and 2.

At operation 415, the system determines an energy profile for the amount of energy to deliver to each location. The system may determine an energy profile that delivers the determined amount of energy. For example, the system may determine a firing time or a firing power to deliver the determined amount of energy. In some examples, the energy emitters may scan across the build material bed. The system may determine an energy profile that will cause the energy emitters to deliver the correct amount of energy to the correct locations as they scan across the build material bed. In some cases, this operation may refer to, or be performed by, a controller as described with reference to FIGS. 1 and 2.

At operation 420, the system delivers a first amount of energy to a first location using a first energy emitter. For example, operation 415 may include determining that the amount of energy determined at operation 410 should be split among and delivered by first and second energy emitters rather than a single energy emitter. Operation 415 may also include determining overall energy profiles for the first and second energy emitters, which may scan across a plurality of locations, based on the energy profile of each location in the scan path of each energy emitter. Operation 420 may include firing the first energy emitter based on the energy profile for the first energy emitter. At operation 425, the system delivers a second amount of energy to the first location using the second energy emitter. For example, operation 425 may include firing the second energy emitter based on the energy profile for the second energy emitter. In some cases, operations 420 and 425 may refer to, or be performed by, energy emitters as described with reference to FIG. 1 or lasers as described with reference to FIG. 2.

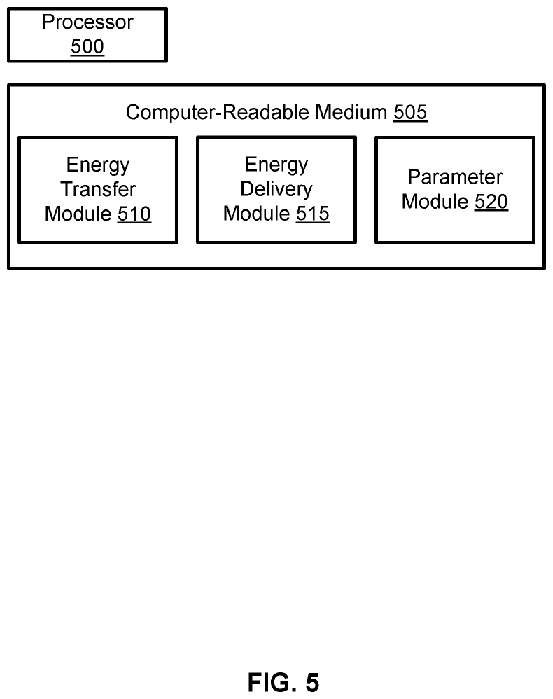

FIG. 5 is a block diagram of an example computer-readable medium 505 including instructions that, when executed by a processor 500, cause the processor 500 to determine energy delivery to fuse build material based on thermal transfer. The example shown includes processor 500 and computer-readable medium 505. The computer-readable medium 505 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 500 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc.

Computer-readable medium 505 may include energy transfer module 510, energy delivery module 515, and parameter module 520. As used herein, a “module” (in some examples referred to as a “software module”) is a set of instructions that when executed or interpreted by a processor 500 or stored at a processor-readable medium realizes a component or performs a method. Energy transfer module 510 includes instructions that, when executed, cause the processor 500 to compute the amount of energy to be received from other locations of the build material bed for each of a plurality of locations of a build material bed. For example, energy transfer module 510 may cause the process 500 to compute the amount of energy that will be received due to thermal transfer after energy is delivered to the build material bed.

Energy delivery module 515 may cause the processor 500 to compute the amount of energy to deliver to each location using a plurality of energy emitters to achieve a fusing condition based on the amount of energy to be received from the other locations. For example, for each location to be fused, the energy delivery module 515 may cause the processor 500 to compute the amount of energy beyond what is received from the other locations that should be delivered for that location to reach the fusing condition.

Parameter module 520 may cause the processor 500 to determine parameters of the plurality of energy emitters to deliver the computed amount of energy. For example, parameter module 520 may cause the processor 500 to determine a parameter or parameters for each energy emitter that will cause the computed amount of energy to be delivered to each location when the plurality of energy emitters are operated according to the determined parameters. The parameters may be parameters that control or affect the amount of energy that is delivered from the plurality of energy emitters to the build material bed. In an example, when executed by processor 500, energy transfer module 510, energy delivery module 515, or parameter module 520 may realize the controller as described with reference to FIGS. 1 and 2.

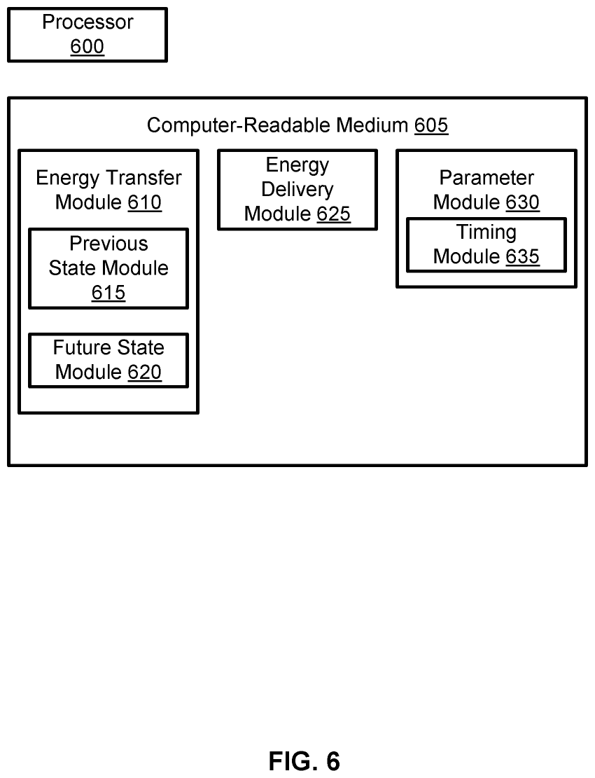

FIG. 6 is a block diagram of another example computer-readable medium 605 including instructions that, when executed by a processor 600, cause the processor 600 to determine energy delivery to fuse build material based on thermal transfer. The example shown includes processor 600 and computer-readable medium 605. Processor 600 may be an example of, or include aspects of, the corresponding element or elements described with reference to FIG. 5. Computer-readable medium 605 may be an example of, or include aspects of, the corresponding element or elements described with reference to FIG. 5.

Computer-readable medium 605 may include energy transfer module 610, energy delivery module 625, and parameter module 630. Energy transfer module 610 may be an example of, or include aspects of, the corresponding element or elements described with reference to FIG. 5; energy delivery module 625 may be an example of, or include aspects of, the corresponding element or elements described with reference to FIG. 5; and parameter module 630 may be an example of, or include aspects of, the corresponding element or elements described with reference to FIG. 5.

Energy transfer module 610 may include previous state module 615 and future state module 620. The energy transfer module 610 may include instructions that cause the processor 600 to compute the amount of energy to be received at each location based on a predicted thermal state of a current layer of the build material. The previous state module 615 may cause the processor 600 to compute the amount of energy to be received at each location based on a thermal state of a previous layer of the build material bed that already received energy from the plurality of energy emitters. The previous state module 615 may cause the processor 600 to compute the thermal state of the previous layer based on a model, an amount of energy delivered to the previous layer, a thermal image of the previous layer, or the like. For example, the thermal image may indicate the temperatures of various locations on the build material bed at the time the thermal image was taken.

The future state module 620 may cause the processor 600 to compute a predicted thermal state of a future layer. For example, the future state module 620 may cause the processor 600 to predict the thermal state with a model, predict the thermal state based on a predicted delivery of energy to the future layer (e.g., based on a slice from a 3D model for the future layer), or the like. The energy transfer module 610 may cause the processor 600 to compute the amount of energy to be received at each location based on the amount of energy received from the previous layer, the amount of energy received from the current layer, and the amount of energy received from future layers. The energy delivery module 625 may adjust the computed amount of energy to be delivered to each location based on the thermal state of previous layer or the predicted thermal states of the current or future layers. For example, the energy delivery module 625 may adjust the computed amount of energy to achieve or avoid a fusing or overheating condition.

Parameter module 630 may include timing module 635. Timing module 635 may cause the processor 600 to determine a timing for firing each energy emitter to be fired. In an example with scanning energy emitters, timing module 635 may cause the processor 600 to determine a timing by determining when to fire each energy emitter to deliver the computed amount of energy to the correct location on the build material bed. In some examples, the timing module 635 may cause the processor 600 to determine to deliver energy to locations having a first set of characteristics before delivering energy to locations having a second set of characteristics (e.g., edges or fine features before or after a bulk of the object). In an example, when executed by processor 600, energy transfer module 610, previous state module 615, future state module 620, energy delivery module 625, parameter module 630, or timing module 635 may realize the controller as described with reference to FIGS. 1 and 2.

In this disclosure and the following claims, the word “or” indicates an inclusive list such that, for example, the list of X, Y, or Z means X or Y or Z or XY or XZ or YZ or XYZ. In the description, the statement that an element may include X, Y, or Z does not exclude other examples in which the element includes none of X, Y, and Z. Also, the phrase “based on” is not used to represent a closed set of conditions. For example, a step that is described as “based on condition A” may be based on both condition A and condition B. In other words, the phrase “based on” shall be construed to mean “based at least in part on.”

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a plurality of energy emitters to deliver energy to a material bed to fuse build material at a plurality of locations receiving the energy; and
a controller to:
determine an amount of energy to deliver to each location to achieve a fusing condition based on data indicating the plurality of locations to be fused and based on predicted thermal transfer between the plurality of locations receiving the energy, and
cause the plurality of energy emitters to deliver the determined amount of energy to each location of the material bed.

2. The system of claim 1, wherein the plurality of energy emitters includes a two-dimensional array of lasers.

3. The system of claim 2, wherein the controller is to cause the two-dimensional array of lasers to deliver the determined amount of energy to each location by adjusting a laser power or a firing time of each laser.

4. The system of claim 1, further comprising an agent delivery system to apply an agent to additional locations on the material bed.

5. The system of claim 1, further comprising a thermal camera, wherein the controller is to adjust the determined amount of energy based on an image captured by the thermal camera.

6. A method, comprising:
determining a heat map based on data indicating locations of a build material bed to be fused and based on predicted thermal transfer between the locations to be fused;
determining an amount of energy to deliver to each location of the build material bed based on the heat map and the data indicating the locations of the build material bed to be fused; and
delivering the determined amount of energy using a plurality of energy emitters to fuse build material at the locations of the build material bed to be fused.

7. The method of claim 6, wherein determining the heat map comprises convolving a kernel with a slice of a three-dimensional model, wherein the data indicating the location of the build material bed to be fused comprises the slice of the three-dimensional model.

8. The method of claim 6, wherein delivering the determined amount of energy using the plurality of energy emitters comprises delivering a first amount of energy to a first location using a first energy emitter and delivering a second amount of energy to the first location using the second energy emitter.

9. The method of claim 6, further comprising determining an amount of agent to deliver to each location of the build material bed, wherein determining the amount of energy to deliver to each location comprises determining the amount of energy to deliver to each location based on the heat map, the data indicating the locations of the build material bed to be fused, and the amount of agent determined for each location.

10. The method of claim 6, further comprising determining an energy profile for the amount of energy to deliver to each location, wherein the plurality of energy emitters scan relative to the build material bed, and wherein delivering the determined amount of energy comprises delivering the determined amount of energy according to the energy profile while scanning the plurality of energy emitters.

11. A non-transitory computer-readable medium comprising instructions that, when executed by a processor, cause the processor to:
for each of a plurality of locations of a build material bed, compute the amount of energy to be received from other locations of the build material bed;
compute the amount of energy to deliver to each location using a plurality of energy emitters to achieve a fusing condition based on the amount of energy to be received from the other locations; and
determine parameters of the plurality of energy emitters to deliver the computed amount of energy.

12. The computer-readable medium of claim 11, wherein the instructions cause the processor to compute the amount of energy to be received at each location based on a thermal state of a previous layer of the build material bed that already received energy from the plurality of energy emitters and a predicted thermal state of a current layer of the build material.

13. The computer-readable medium of claim 12, further comprising instructions that cause the processor to compute the thermal state of the previous layer based on a thermal image of the previous layer.

14. The computer-readable medium of claim 11, further comprising instructions that cause the processor to compute a predicted thermal state of a future layer and to adjust the computed amount of energy to be delivered to each location based on the predicted thermal state of the future layer.

15. The computer-readable medium of claim 11, wherein the instructions that cause the processor to determine the parameters of the plurality of energy emitters include instructions to determine a timing for firing each energy emitter to be fired.
